(19) United States
(12) Patent Application Publication
(10) Pub. No.: US 2015/0351442 A1
(43) Pub. Date: Dec. 10, 2015

(54) HIGH PRESSURE PROCESSING OF JUICE CONTAINING PROBIOTICS

(71) Applicant: CHIC GROUP CO., LTD., Shanghai (CN)

(72) Inventors: Yanming ZHU, Shanghai (CN); Lei WANG, Shanghai (CN); Zheng TANG, Shanghai (CN)

(21) Appl. No.: 14/723,696

(22) Filed: May 28, 2015

Related U.S. Application Data
(60) Provisional application No. 62/008,845, filed on Jun. 6, 2014.

(51) Int. Cl. A23L 2/04; A23L 2/52

(52) U.S. Cl. CPC A23L 2/04; A23L 2/52; A23Y 2220/67; A23V 2002/00; A23Y 2220/03; A23Y 2220/17; A23Y 2220/00; A23Y 2220/49

(57) ABSTRACT

The objective of the invention is to provide an improved method of making healthier juice products inoculated with probiotics, wherein the juice includes but is not limited to apple juice, coconut water, coconut milk, orange juice and/or carrot juice. The present invention relates to a method of pressure treating a juice containing probiotics. Vegetative cells of harmful microorganisms and enzymes are inactivated by applying high pressure while maintaining the activity of the probiotics. The juice preferably is dairy-free. The juice could be any dairy-free juice, such as a fruit juice, a vegetable juice, or their combination. Fruit and/or vegetable juice are prepared by any traditional methods, including but not limited to, washing, extracting by optionally treating with enzyme(s), centrifuging and packing. Probiotics, e.g., probiotics from bacterial spores, such as the spores of Bacillus coagulans and/or Lactobacillus plantarum, stay alive and active in the fruit or vegetable juice after high pressure pasteurization, as well as during the product shelf life.

### CROSS-REFERENCE TO RELATED APPLICATION

The present patent application claims the benefits of U.S. Provisional Application, Serial No. 62/008,845, filed on Jun. 6, 2014, the disclosures of which are herein incorporated by reference.

### BACKGROUND

Compared with the traditional thermal processing of juice products, high pressure processing (HPP) is widely recognized as a non-thermal pasteurization method, which is most effective in maintaining the flavor, color, texture and nutritional properties of foods and beverages. HPP is a method of preserving and pasteurizing food, in which a product is processed under a very high pressure, leading to inactivation of certain microorganisms and enzymes in food. HPP utilizes isostatic or hydrostatic pressure which is equal from every direction. Neither the size of a product's container nor its thickness plays a role in the effectiveness of pasteurization by HPP. The first product pasteurized by high pressure (600 MPa) was commercialized in Japan, since then many inventions used HPP to pasteurize foods. European patent, EP 0480422B1, claims a method for treating fruit juice containing pectin and pectinase with high pressure. The resulting juice featured a superior quality than the juice subjected to the conventional thermal processing. Chinese patent publication CN102429029A provides a production method of low-sugar fruit juice with milk added, wherein the juice with milk is homogenized at 20-25 MPa to pasteurize it. The homogenization was the source of the high pressure. European patent publication 1051087A2 relates to a method for pasteurizing apple juice using HPP to inactivate microorganisms in order to extend the shelf-life of the juice.

HPP will not inactivate the spores of some microorganisms unless the temperature is elevated to 75° C. or higher. As reported in Food Bioprocess Technol (2011) 4:458-468, ultra high pressure (700-900 MPa) combined with elevated temperature (80-100° C.) inactivated the spores of Clostridium sporogenes in milk. It was found that at low temperature, the germination of spore was not possible. Dormant Bacillus coagulans spores are highly resistant to many physical and chemical agents including heat, drying, chemicals such as hydrogen peroxide, radiation and high pressure.

Probiotics are friendly bacteria which can survive in the human digestive system and have been proved to have the ability to balance the intestinal bacteria flora, and to improve the digestive ability. Products containing probiotics available in the market are mainly yogurt or some other dairy products. However, few dairy-free probiotics products have been launched. There are products containing Lactobacillus plantarum 299v, kefir culture, L. plantarum Heal9 in the market. Most of the current probiotics containing products, including dairy products and diary-free products, are thermally pasteurized to inactivate harmful bacteria and enzymes. Thermal process is, however, detrimental to nutrients, color and flavor which are undesirable to consumers. Chinese patent publication CN 101708018A discloses a beverage with Lactobacillus-casei added which is homogenized by high pressure but before the addition of probiotics the beverage is thermally treated at about 100° C. for about 2.5 hours, which causes nutrients loss. European patent publication EP 2432334A1 illustrates a Lactobacillus added citrus fruit juice.

The present inventors discovered that, using HPP to pasteurize juices inoculated with Bacillus coagulans spores, a new product can be attained with superior attributes like long shelf-life, higher nutrient, and more natural.

### SUMMARY OF THE INVENTION

The invention provides a method of preparing a juice product containing live probiotics, comprising

(1) mixing a juice with probiotics to obtain a juice-probiotics mixture at a concentration of 10⁵ to 10¹² cfu of probiotics per ml of the juice mixture, with optional stirring performed at about 10° C. to about 60° C. for about 1 minute to about 30 minutes, and wherein the juice is a fruit juice, vegetable juice or combination thereof; and

(2) subjecting the juice-probiotics mixture to high pressure processing (HPP), wherein the HPP is conducted at a pressure ranging from 100 MPa to 1,000 MPa for about 1 minute to about 30 minutes, preferably for about 1 minute to about 20 minutes, at a temperature of 5° C. to 80° C., or 5° C. to 70° C., or 5° C. to 65° C., or 5° C. to 60° C., or 5° C. to 55° C., or 5° C. to 50° C., or 5° C. to 45° C., or 5° C. tO 40° C., or 5° C. to 35° C., or 5° C. to 30° C., or 5° C. to 25° C., or 5° C. to 20° C., to obtain the juice product containing live probiotics.

Alternatively, in the method of preparing the juice product containing probiotics described above, step (1) is preceded with a step of providing the juice for mixing with the probiotics in step (1).

In one of the embodiments of the method of preparing the juice product, the juice-probiotics mixture is put in a container having a flexible wall before the HPP in step (2). The container can be a plastic container or any other flexible container.

### DETAILED DESCRIPTION OF THE INVENTION

The juice mixed with probiotics in step (1) of the method of preparing the juice product of the invention is preferably dairy free, or a fresh juice, or a dairy-free fresh juice. The juice product containing live probiotics prepared by the method of the invention is preferably dairy free. The fresh juices are prepared by any conventional fruit juice preparation method, such as extraction, enzymatic hydrolysis, centrifugation and filtration. Probiotics is then added to the prepared juices. The mixture is stirred gently for 1 minute to 30 minutes at a temperature of 10° C-60° C. The final count of probiotics in the juice ranges from 10⁵ to 10¹² cfu/mL. The prepared juice with probiotics is filled into a container having flexible wall, e.g., a plastic container such as a plastic bottle or pouch, sealed and subjected to HPP.

The juice used in this invention can be a fruit juice, a mixture of fruit juices, a vegetable juice, a mixture of vegetable juices or a mixture of at least one fruit juice with at least one vegetable juice, with or without addition of extra sugar, sweetener or acid. The juice Brix ranges from 6 to 25, and the pH value ranges from 2.5 to 8. Examples of the juice include, but not limited to, fruit juices, such as apple juice, coconut juice, or orange juice, and vegetable juices, such as carrot juice.

As used herein, the term “probiotics” refer to beneficial bacteria, which can survive in the human digestive system and have the ability to balance the intestinal bacteria flora, and to improve the digestive ability. Probiotics can include bacteria of the Lactobacillus genus and Bifidobacterium genus naturally existing in the intestine of healthy mammals, particularly, humans. Examples of probiotics are Lactobacillus plantarum, Lactobacillus acidophilus, Lactobacillus casei, Bifidobacterium bifidum, Bifidobacterium longum, Bifidobacterium breve, Bifidobacterium infantis, Bifidobacterium lactis, and Bacillus coagulans.

Probiotics used in this invention can be a spore forming Bacillus coagulans strain, or a Lactobacillus plantarum strain, or their combination with a number ratio of Bacillus coagulans to Lactobacillus plantarum ranging from 1:99 to 99:1, 1:50 to 50:1, 1:10 to 10:1, 1:5 to 5:1, or approximately 1:1. Before mixing the probiotics with the juice to get a juice having the desired final concentration of the probiotics, probiotics powder can be mixed with the prepared juices at a temperature in the range of 4° C.-100° C. to get a stock with a high count of probiotics in a liquid state for further dilution with the target juice to obtain a juice with an appropriate final concentration of 10⁵ to 10¹² cfu/ml for HPP.

HPP is used to pasteurize the juice product from the above step by destroying harmful microorganisms and inactivating most enzymes. Flavor and taste of the juice product are preserved much better by pasteurizing through HPP compared to the traditional thermal pasteurization. In addition, thermal pasteurization will deactivate the probiotics. The pressure and holding time parameters for high pressure pasteurization can range from 100 MPa to 1,000 MPa, 100 MPa to 800 MPa, 100 MPa to 500 MPa, 100 MPa to 300 MPa, 500 MPa to 1,000 MPa, 500 MPa to 800 MPa, 500 MPa to 700 MPa, or 600 MPa to 700 MPa, for 1 minute to 20 minutes. The temperature during the HPP treatment can range from 5° C. to 80° C.

The high pressure pasteurized products can be chilled by any conventional method and stored at a temperature ranging from 0° C. to 40° C. for 1 month to 20 months.

### Example 1

### A. Juice Preparation

One hundred tons of apples were prepared by any conventional methods, such as washing, sanitizing, and rinsing for further processing. Washing was done with water at a temperature ranging from 1° C. to 90° C. Sanitizing agents such as chlorine or its derivatives, peroxyacetic acid, or any organic/inorganic bases were added to the water during the wash or separately added into a second wash before the final rinse. Apple juice was extracted by any conventional method available, including the optional addition of macerating enzyme(s).

Apple juice might or might not be centrifuged at a speed ranging from 100 to 10,000 rpm for 1 to 30 minutes. If centrifuged, the centrifugation temperature was maintained at a temperature ranging from 5° C. to 45° C. The clarified apple juice was prepared for further processing.

### B. Probiotics Stock Solution Preparation

One gram to 100 grams of probiotics powder, containing 10² to 10¹² cfu/g of Bacillus coagulans, Lactobacillus plantarum or a mixture thereof, were mixed with 1 to 100 liters of the juice until complete suspension, wherein the temperature was maintained in the range of 5° C.-60° C. This stock solution was used for the inoculation of the apple juice.

### C. Stock Solution Application

One liter of the concentrated stock solution was mixed with 10-10⁶ liter prepared apple juice at a temperature ranging from 5° C. to 60° C. with stirring at a speed of 1-500 rpm for 1-30 min.

The juice mixture was then filled into a 50 mL to 5 L plastic bottle, cup or pouch and sealed with the headspace volume within 0.1% to 10% of the total bottle or pouch volume and minimizing air or any other gases in the package.

The packaging material could be, but not limited to, polyethylene (PE), polyethylene terephthalate (PET), nylon, ethylene vinyl alcohol (EVOH), or a mixture thereof.

The sealed plastic package was loaded into the chamber of a HPP unit for pasteurization. The processing pressure ranged from 100 MPa to 1 000 MPa, 100 MPa to 800 MPa, 100 MPa to 500 MPa, 100 MPa to 300 MPa, 500 MPa to 1,000 MPa, 500 MPa to 800 MPa or 600 MPa to 700 MPa, The holding time ranged from 1 to 30 minutes, and the temperature ranges from 10° C. to 60° C.

The pasteurized products were dried and chilled using forced air or any other conventional methods of drying/cooling, and stored at the temperature ranged from 1° C. to 30° C. for 1-12 months.

### Example 2

### A. Juice Preparation

One hundred tons of coconuts were washed, sanitized and rinsed for further processing. Washing was done with water at a temperature at 1° C. to 90° C. Sanitizing agents such as chlorine or its derivatives, peroxyacetic acid or any organic/inorganic bases were added to the water during the wash or separately added into a second wash before the final rinse.

The juice was collected in a sanitary condition from the washed coconut for further process.

### B. Probiotics Stock Solution Preparation

One to 100 grams of probiotics powder containing 10² to 10¹² cfu/g of Bacillus coagulans or Lactobacillus plantarum and/or their combination, was added into 1 liter to 100 liters of the prepared coconut juice and mixed to complete dispersion at a temperature in the range of 5° C.-60° C., to get a high concentration probiotics stock in a liquid state for further mixing process. The temperature of the probiotics stock solution was maintained at a temperature in the range of 5° C.-60° C.

### C. Stock Solution Application

One liter of the concentrated probiotics stock solution was mixed with 1-10⁶liter of the prepared coconut juice The mixing was performed between 1-30 minutes at 1-500 rpm at a temperature of 5° C.-60° C.

The juice mixture was then filled into 50 mL-5 L plastic bottles, cups or plastic bags and sealed with the headspace volume controlled within 1% to 5% of the total bottle, cup or bag volume and minimizing air or any other gases in the package.

The packaging material could be but not limited to polyethylene (PE), polyethylene terephthalate (PET), nylon, ethylene vinyl alcohol (EVOH), or combination of some or all of these materials.

The sealed plastic package was loaded into the chamber of high pressure machine for pasteurization. The pressure for processing ranged from 100 MPa to 800 MPa, and holding time ranging from 1 min to 30 min, and the temperature of the high pressure transmit medium ranges from 5° C. to 90° C.

The pasteurized bottle/cup/bag/any flexible containers of the products were dried and chilled using forced air or any other conventional methods of drying/cooling, and stored at the temperature ranging from 1° C. to 30° C. for 1-10 months.

### Example 3

### A. Juice Preparation

One hundred tons of each oranges, and carrots, were washed, sanitized and rinsed for further processing. The washing was done with water at 1° C. to 90° C. Sanitizing agents such as chlorine or its derivatives, peroxyacetic acid or any organic/inorganic bases were added to the water during the wash or separately added into a second wash before the final rinse.

Oranges and carrots were juiced with a juice extractor respectively at an extraction temperature ranging from 1° C. to 90° C. After extraction, juices were maintained at 20° C. to 50° C. for 30 minutes to 10 hours. Macerating enzyme(s) might or might not be added into orange juice and carrot juice for hydrolysis, if needed, the enzyme(s) concentration range would be from 0.001% to 1% of the total juice volume.

During the juicing process, Vitamin C or other natural antioxidants or mixture of antioxidants were added to the juices to protect juice color or modify the pH. After enzymatic hydrolysis if needed in some cases, both orange and carrot juices were subjected to centrifugation at a speed ranges from 100 to 20,000 rpm/min for 1 minute to 30 minutes, the centrifugation temperature was maintained at temperatures ranging from 5° C. to 45° C. In some cases, centrifugation might not be needed. The orange and carrot juices were mixed with an orange to carrot ratio from 1:3 to 3:1 (v/v).

### B. Probiotics Stock Solution Preparation

One gram to 100 grams of probiotics powder, containing 10² to 10¹² cfu/g of Lactobacillus plantarum or Bacillus coagulans and/or their combination, was combined with 1 liter to 100 liters of the prepared juice mixture until complete mixing to get a high concentration of probiotics stock solution for further dilution. The temperature of mixing process was maintained in the range of 5° C. to 60° C.

### C. Stock Solution Application

One liter of the high concentration probiotics stock solution was mixed with 1-10⁶ liter of the prepared juice mixture maintaining the temperature at 5° C. to 60° C. The mixing process was progressed with stirring at the speed of 1-500 rpm for 1-30 min. The juice mixture was then filled into 50 mL-5 liters plastic bottles, cups or pouches and sealed with the headspace volume within 1%-10% of the total bottle, cup or pouch volume.

The packaging material could be but not limited to polyethylene (PE), polyethylene terephthalate (PET), nylon, ethylene vinyl alcohol (EVOH), or combination of some or all of these materials.

The sealed plastic package was loaded into the chamber of high pressure machine for pasteurization. The pressure for processing ranged from 100 MPa to 800 MPa, the pressure holding time ranged from 1 min to 30 min, and the temperature of pressure transmit medium ranged from 5° C. to 90° C.

The pasteurized bottles/cups/pouches/any other flexible container of the products were dried and chilled using forced air or any other conventional methods of drying/cooling, and stored at the temperature ranging from 1° C. to 40° C. for 1-12 months.

### REFERENCES

EP 0480422 B1 A method for treating fruit juice with high pressure

CN 102429029 A Production method of low-sugar fruit juice milk

EP 1051087 A2 Method for ultra high pressure inactivation of microorganisms in juice products

CN 101708018 A Lactobacillus-casei probiotics beverage and preparation method thereof

Y Shao, HS Ramaswamy. (2011). Clostridium sporogenes-ATCC 7955 spore destruction kinetics in milk under high pressure and elevated temperature treatment conditions. Food and Bioprocess Technology, 4(3):458-468.

Edwin Ananta, Volker Heinz, Oliver Schluter, and et al. (2001). Kinetic studies on high-pressure inactivation of Bacillus stearothermophilus spores suspended in food matrices. Innovative Food Science & Emerging Technologies, 2(4):261-272.

F.C. Lavinas, M.A.L. Miguel, M.L.M. Lopes, and et al. (2008). Effect of High Hydrostatic Pressure on Cashew Apple (Anacardium occidentale L.) Juice Preservation. Journal of Food Science, 73(6):273-277.

Daniel N. Silaa,Thomas Duvettera, Ans De Roeck, and et al. (2008). Texture changes of processed fruits and vegetables: potential use of high-pressure processing. Trends in Food Science & Technology, 19(6):309-319.

1. A method of preparing a juice product containing probiotics, comprising
(1) mixing a juice with probiotics to obtain a juice-probiotics mixture at a concentration of 10⁵ to 10¹² cfu of probiotics per ml of the juice-probiotics mixture, and wherein the juice is a fruit juice, a mixture of fruit juices, a vegetable juice, a mixture of vegetable juices, or a combination of at least one fruit juice and at least one vegetable juice; and
(2) subjecting the juice-probiotics mixture to high pressure processing (HPP), wherein the HPP is conducted at a pressure ranging from 100 MPa to 1,000 MPa for about 1 minute to about 30 minutes, at a temperature ranging from 5° C. to 80° C. to obtain the juice product containing probiotics.

2. The method of claim 1, wherein step (1) is preceded with a step of providing the juice for mixing with the probiotics.

3. The method of claim 1, wherein the juice-probiotics mixture from step (1) is stirred at about 10° C. to about 60° C. for about 1 minute to about 30 minutes before step (2).

4. The method of claim 1, wherein the juice mixed with the probiotics is a diary-free juice, and the juice product prepared is dairy free.

5. The method of claim 4, wherein the dairy-free juice mixed with the probiotics is a fruit juice or mixture of fruit juices.

6. The method of claim 5, wherein the dairy-free juice is apple juice, coconut juice, orange juice, or a mixture thereof.

7. The method of claim 4, wherein the dairy-free juice is a vegetable juice or a mixture of vegetable juices.

8. The method of claim 7, wherein the dairy-free juice is carrot juice.

9. The method of claim 4, wherein the dairy-free juice is fresh.

10. The method of claim 1, wherein the probiotics is one or more spore forming Bacillus coagulans strains, one or more Lactobacillus plantarum strains, or combination thereof.

11. The method of claim 10, wherein the probiotics is a mixture of one or more spore forming Bacillus coagulans strains and one or more Lactobacillus plantarum strains.

12. The method of claim 11, wherein the mixture of one or more spore forming Bacillus coagulans strains and one or more Lactobacillus plantarum strains has a number ratio of Bacillus coagulans to Lactobacillus plantarum ranges from 1:99 to 99:1.

13. The method of claim 1, wherein the high pressure processing (HPP) is performed at a temperature of at a temperature ranging from 5° C. to 50° C. in step (1).

14. The method of claim 1, wherein the high pressure processing (HPP) is performed at a pressure ranging from 100 MPa to 800 MPa in step (1).

15. The method of claim 1, wherein in step (2) the high pressure processing (HPP) is performed with the juice-probiotics mixture in a container having at least one flexible wall.

16. The method of claim 1, wherein in step (2) the high pressure processing (HPP) is performed with the juice-probiotics mixture in a plastic container.

17. The method of claim 16, wherein the plastic is selected from polyethylene (PE), polyethylene terephthalate (PET), nylon, ethylene vinyl alcohol (EVOH), or a mixture thereof.

18. The method of claim 15, wherein the high pressure processing (HPP) is performed with the container sealed with the headspace volume within 0.1% to 10% of the total internal volume of the container.

19. The method of claim 1, wherein before mixing the probiotics with the juice in step (1), the probiotics is mixed with a juice at a temperature in the range of 4° C.-100° C. to obtain a stock liquid, followed by mixing the stock liquid with a volume of a juice to obtain a juice-probiotics mixture at a concentration of 10⁵ to 10¹² cfu/ml before step (2).

20. The method of claim 1, wherein the juice for mixing the probiotics has Brix ranging from 6 to 25.

21. The method of claim 1, wherein the juice for mixing the probiotics has a pH ranging from 2.5 to 9.

22. The method of claim 1, wherein the high pressure processing (HPP) is performed at a temperature ranging from 5° C. to 40° C. in step (1).

23. The method of claim 1, wherein the high pressure processing (HPP) is performed at a pressure ranging from 100 MPa to 500 MPa in step (1).

24. The method of claim 1, wherein the high pressure processing (HPP) is performed at a temperature ranging from 5° C. to 30° C. in step (1).

25. The method of claim 1, wherein the high pressure processing (HPP) is performed at a pressure ranging from 100 MPa to 300 MPa in step (1).

26. The method of claim 1, wherein the high pressure processing (HPP) is performed at a temperature ranging from 5° C. to 25° C. in step (1).

27. The method of claim 1, wherein the high pressure processing (HPP) is performed at a pressure ranging from 500 MPa to 1000 MPa in step (1).

28. The method of claim 1, wherein the high pressure processing (HPP) is performed at a pressure ranging from 500 MPa to 800 MPa in step (1).

29. The method of claim 1, wherein the high pressure processing (HPP) is performed at a pressure ranging from 500 MPa to 700 MPa in step (1).

30. The method of claim 1, wherein the high pressure processing (HPP) is performed at a pressure ranging from 600 MPa to 700 MPa in step (1).

31. The method of claim 1, wherein the high pressure processing (HPP) is performed at a temperature of at a temperature ranging from 5° C. to 70° C. in step (1).

32. The method of claim 1, wherein the high pressure processing (HPP) is performed at a temperature of at a temperature ranging from 5° C. to 60° C. in step (1).

33. The method of claim 1, wherein the probiotics is at least one bacteria selected from Lactobacillus plantarum, Lactobacillus acidophilus, Lactobacillus casei, Bifidobacterium bifidum, Bifidobacterium longum, Bifidobacterium breve, Bifidobacterium infantis, Bifidobacterium lactis, and Bacillus coagulans.
